(19) United States
(12) Patent Application Publication
(10) Pub. No.: US 2014/0327885 A1
(43) Pub. Date: Nov. 6, 2014

(54) APPARATUS FOR OBTAINING ENHANCED CONTRAST IN PROJECTED IMAGES USING DIGITAL MICROMIRROR DEVICES

(71) Applicant: David Joseph Mansur, (US)

(72) Inventor: David Joseph Mansur, (US)

(21) Appl. No.: 13/874,847

(22) Filed: May 1, 2013

(51) Int. Cl. H04N 5/74; H04N 9/31

(52) U.S. Cl. CPC H04N 5/7458; H04N 9/3105
USPC 353/31; 353/30

(57) ABSTRACT

A system for projecting digital images of ultraviolet, visible, and infrared scenes in which two or more digital micromirror devices (DMDs) are employed to create projected images which have greater contrast and bit depth than can be achieved with comparable prior art devices. A source DMD creates an image of the digital scene which is used to illuminate a projector DMD, so that the projector DMD is illuminated to an extent proportionate to the corresponding scene brightness, thereby reducing the amount of undesired radiation which would otherwise illuminate the projected scene via scattering, diffraction, and/or spurious reflections from within the projection system. By including dichroic beam-splitters and additional projector DMDs it is possible to project multi-spectral-band images having enhanced contrast and bit depth relative to prior art digital projection systems.

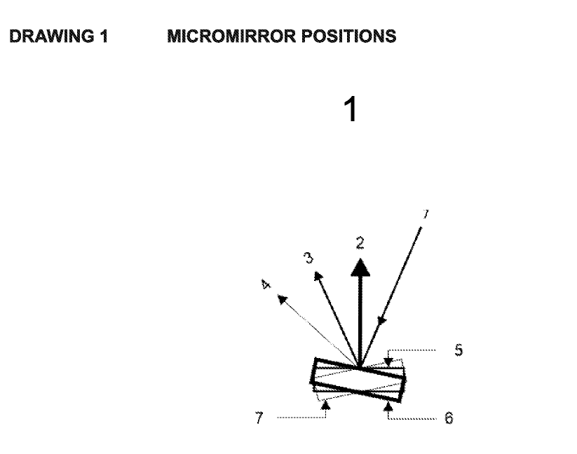

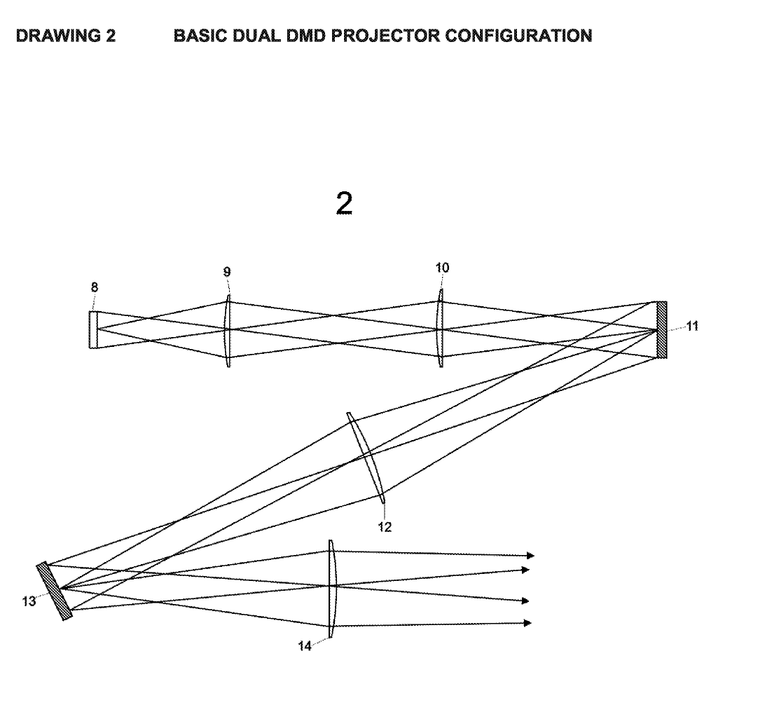

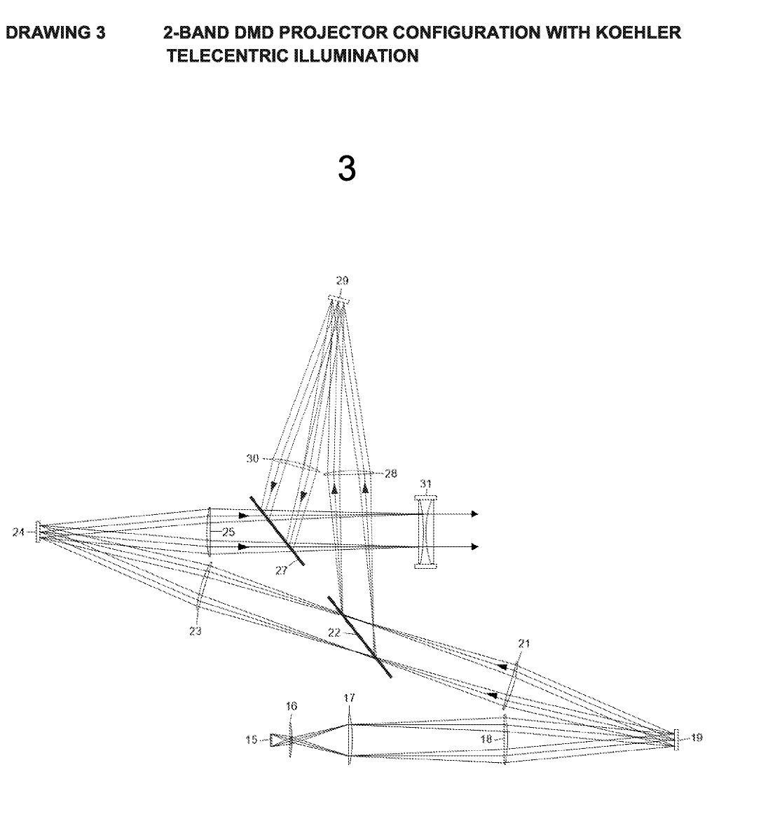

### CROSS-REFERENCE TO RELATED APPLICATIONS

This application claims the benefit of the following pending provisional patent application:

Title: Structured Illumination of a Digital Micromirror Device

Application No.: 61/688,259

Filing Date: May 10, 2012

This provisional patent application described the basic concepts described in the present patent application. During the past year, these concepts have been implemented and demonstrated to be successful in obtaining significantly improved contrast in projected images of visible and infra-red scenes.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract N68335-11-C-0182 awarded by the U.S. Naval Air Warfare Center.

### BACKGROUND OF THE INVENTION

This invention relates generally to the field of apparatus for the projection of images in the ultraviolet, visible, and infrared portions of the spectrum, particularly such apparatus utilizing digital micro-mirror devices (DMDs). Prior art DMD projectors are limited in the scene contrast and dynamic range which they can achieve. This invention provides a means for greatly increasing the achievable contrast and dynamic range of images projected using digital micromirror devices.

Prior art in the area of increasing contrast in images created by DMD projectors includes:
1. METHOD AND APPARATUS FOR INCREASING THE DYNAMIC RANGE OF A PROJECTION SYSTEM; EUROPEAN PATENT 1300008 (INVENTOR: SEAN ADKINS)
2. PROJECTION SYSTEM AND MIRROR ELEMENTS FOR IMPROVED CONTRAST RATIO IN SPATIAL LIGHT MODULATORS U.S. Pat. No. 6,523,961 (INVENTOR: FEDOR A. ILKOV)
3. REDUCED MICROMIRROR MIRROR GAPS FOR IMPROVED CONTRAST RATIO U.S. Pat. No. 6,028,690 A (INVENTOR: ANTHONY DICARLO)
4. DMD EQUIPPED PROJECTOR U.S. Pat. No. 6,874,894 (INVENTOR: TAKATOYO KITAMURA)
5. METHOD AND APPARATUS FOR INCREASING THE DYNAMIC RANGE OF A PROJECTION SYSTEM EUROPEAN PATENT 1300008 (INVENTOR: SEAN ADKINS)
6. PRISM FOR HIGH CONTRAST PROJECTION U.S. Patent 20070252957 (INVENTOR: PENN, STEVEN M.)
7. DIGITAL MICROMIRROR BASED IMAGE SIMULATION SYSTEM U.S. Pat. No. 5,457,493 (INVENTOR MICHAEL LEDDY)
8. PROJECTION SYSTEM AND MIRROR ELEMENTS FOR IMPROVED CONTRAST RATIO IN SPATIAL LIGHT MODULATORS U.S. Pat. No. 6,523,961 (INVENTOR: ILKOV, FEDORA.)
9. Contrast-Improving Methods for Digital Micromirror Device Projectors, Youri Meuret; Patrick De Visschere, Opt. Eng. 42(3), 840-845 (Mar. 01, 2003).
10. Contrast Analysis for DMD-Based IR Scene Projector, Julia Rentz Dupuis, David J. Mansur, Samuel Grant, and Scott P. Newbry. Copyright 2012 Society of Photo-Optical Instrumentation Engineers. This paper was published in The Proceedings of Technologies for Synthetic Environments: Hardware-in-the-Loop Testing XVII.
11. High Dynamic Range DMD-Based IR Scene Projector, Julia Rentz Dupuis, David J. Mansur, Robert Vaillancourt, Ryan Benedict-Gill and Scott P. Newbry; paper presented at Photonics West, San Francisco, Feb. 4- Feb. 7, 2013.

### BRIEF SUMMARY OF THE INVENTION

In view of the limitations of the prior art in providing DMD projectors capable of projecting high contrast images, particularly in the infrared portion of the spectrum, the present invention provides a new and useful means for providing projected images from a DMD-based projector that have higher-contrast than that which is available from prior art devices.

The purpose of the present invention is to provide a new structured illumination of a DMD that serves to enhance the contrast and dynamic range of the final projected images.

In prior art DMD projectors, the DMD is uniformly illuminated by a source of radiation and associated optical elements. The individual mirrors of the DMD are tilted by ±12 degrees in order to steer reflected radiation either towards a projection lens (the ON direction) or towards a radiation absorber (the OFF direction). A multitude of gray levels is achieved by varying the duty cycle with which individual mirrors are tilted between the ON and OFF directions. Individual micro-mirrors in commercially available DMDs are generally square with a linear dimension of 13.7 microns. Individual micro-mirrors diffract light into a cone with a cone-angle of approximately λ/d where λ is the wavelength of the light, d is the linear dimension of the micro-mirror, and where the angle is measured in radians. For visible light with a mean wavelength of 0.55 microns, this cone angle is approximately 0.04 radians or 2.3 degrees. However, for infrared radiation having a wavelength on the order of 10 microns, the diffraction cone angle becomes 10/13.7 radians or 41.8 degrees. As a consequence of this large diffraction angle, a significant portion of the radiation incident on a micro-mirror that is tilted in the OFF direction, is diffracted into the ON direction, thereby increasing the background level of illumination in the projected image. Other factors which reduce the contrast in DMD projected images include reflection of radiation by the DMD windows and other optical elements, scattered energy from DMD components other than the micromirrors, reflection and/or emission of radiation by the surface(s) irradiated when the micro-mirrors are in the OFF state, and emission of radiation by the DMD components.

The present invention serves to greatly reduce this background level of illumination by illuminating the projection DMD only in those areas where micro-mirrors are tilted in the ON direction. This selective or structured illumination of the projection DMD is achieved by using a second DMD, preceding the projection DMD, that is controlled to create the same images and which is imaged onto the projection DMD. In this manner, the projection DMD is illuminated only in those areas where radiation is desired in the final image, thus eliminating OFF pixels from being illuminated and subsequently contributing, by means of diffraction or scattering, to an undesired background illumination of the image plane.

Even in the absence of undesired radiation, this use of dual DMDs serves to increase the contrast in the final image plane. If the maximum and minimum values of the transmission T are Tₘₐₓ and Tₘᵢₙ then the contrast C in the single DMD system is given by C₁=Tₘₐₓ/Tₘᵢₙ, while the contrast for the dual DMD system is C₂=C₁².

### BRIEF DESCRIPTION OF THE DRAWINGS

Drawing 1 illustrates the manner in which an individual micromirror of a DMD can be tilted to either their nominal OFF state or their ON state. Incoming radiation, 1, is reflected by micromirror 8, either in direction 2 to the projection lens, or in direction 4 to an absorbing surface.

Drawing 2 illustrates the basic layout of the invention. The radiation source 8 is imaged by the first source lens 9 onto the second source lens 10 which forms an image of uniformly illuminated source lens 9 onto the surface of the source DMD 11. Just ahead of DMD 11 is relay lens 12 which forms a 1:1 image of the source DMD 11 onto the projection DMD 13. Projection lens 14 either forms a real image of DMD 13 on a screen, or a virtual image that can be viewed by a telescope or other viewing optical system.

Drawing 3 shows the preferred configuration of this invention for dual-spectral band operation. Source 15 is imaged by source lens 16 onto a second source lens 17. Source lens 17 forms an image of lens 16 onto a third source lens 18, which produces a collimated beam from each point on the source 15. This arrangement of source and source lenses comprises a Koehler telecentric system for illuminating the source DMD 19 with a high degree of uniformity. Radiation from the source that is reflected by micromirrors goes to the next optical element, relay lens 21 which, in combination with relay lens 23, forms an image of DMD 19 onto the surface of projection DMD 24. A dichroic beam-splitter 22 serves to transmit radiation in a first spectral band A towards projection DMD 24, while at the same time reflecting radiation in spectral band B towards projection DMD 29. Relay lenses 23 and 28, in combination with relay lens 21, serve to image source DMD 19 onto projection DMDs 24 and 29 respectively. Radiation reflected by ON state micromirrors in projection DMDs 24 and 29 proceed to relay lenses 25 and 30 respectively and are transmitted or reflected, respectively, by beam-combiner 27. The combined radiation in bands A and B then proceed to projection lens 31, forming a high-contrast two-band image at infinity (to be viewed by an imaging system under test) or on a projection screen at a finite distance.

### DETAILED DESCRIPTION OF THE INVENTION

The present invention generally comprises a means of illuminating a DMD with a structured illumination whose structure is imposed by a source-conditioning DMD. The purpose of this invention is to improve the overall dynamic range of the total projected image in the form of improved contrast and grayscale bit depth. Contrast refers to the ratio of the projected light level associated with all micromirrors on to the projected light level associated with all micromirrors off; contrast also refers to the ratio of the brightest to darkest light level within a given image. The background contributions to the projected image when the micromirrors are in the off position are due mainly to scattering and/or diffraction of the optical source energy by the micromirror array and by whatever structural elements are accessible between the micromirrors; it is this energy that limits the contrast in a traditional single DMD optical system. The structured source discussed here is dynamically programmable for each image displayed by the projector DMD. For any given image, high optical intensity can therefore be directed to areas of the projector DMD which will display bright objects, and low or zero optical intensity can be directed to areas of the projector DMD which will display dark objects. The result is improved overall contrast, achieved by the reducing or eliminating scattered and diffracted radiation levels in the darker regions of the image.

Grayscale bit depth is typically achieved via pulse width modulation in DMD-based optical systems where the effective duty cycle of micromirrors in their on versus off positions over a frame duration is varied to achieve different grayscale levels as detected by a sensor which is integrating over the frame duration. The grayscale bit depth is therefore limited by the frame rate coupled with the fastest rate at which the micromirrors can switch position. Grayscale can also be realized spatially with a grayscale to black and white conversion algorithm. Because the structured illumination has an associated gray-scaling, its multiplication with the grayscale image displayed by the projector DMD results in a multiplicative total grayscale bit depth which is increased from the grayscale bit depth of either DMD on its own.

This description focused on structured illumination for a projector system, however, the use of two DMDs in series can also be applied in areas of imaging and spectrometer instruments.

The optical layout of the structured illumination is as follows. An optical source is used to illuminate the source DMD at normal or off-normal incidence. The optical source may be a lamp, bulb, filament, glow bar, laser, or light emitting diode and may fall within any portion of the spectral range from the ultraviolet through and including the long-wave infrared. The ON-state energy from the source DMD is then collected and an image of the source-conditioning DMD is formed on the projector DMD. The on-state energy from the projector DMD is then collected by a projection lens which typically forms an image of the projector DMD on a screen for viewing or collimates the energy such that an imaging system can form an image of the projector DMD on its focal plane array. Total internal reflection prisms can also be used for illumination and projection at each DMD.

The simplest realization of this approach is to directly illuminate the source-conditioning DMD with an image of the first source lens and subsequently image the on-state reflected energy from the source-conditioning DMD onto the projector DMD. The on-state energy from the projector DMD is then collimated by a projector lens or imaged onto a screen for viewing.

In its original conception, the source-conditioning DMD is operated in binary mode where each micromirror is in either the on or off position for the duration of the projector DMD frame. The source DMD is frame synched with the projector DMD, and the image stream displayed by the source-conditioning DMD is a transformed version of the original image stream to be produced by the two DMDs in series. The transformation of the image stream for the source-conditioning DMD converts intensity grayscale of the square root of the original image stream on a per-pixel basis to a spatially grayscaled image composed of binary micromirror values. The square root results in the equal splitting of contributions between the source-conditioning and projector DMDs (each displays an image proportional to the square root of the original image). Ratios other than the square root may also be used to preferentially weight the contributions between the source-conditioning and projector DMDs. The images to be displayed may be brightened to preserve the maximum intensity of the scene since each DMD can only attenuate and not amplify the illumination. Bright areas are realized with a high spatial duty cycle pattern of off and on micromirrors where the duty cycle is proportional to the intensity relative to the maximum intensity. Similarly, dark areas are realized with a low duty cycle pattern of off and on micromirrors where the duty cycle is proportional to the intensity relative to the maximum intensity. A number of black and white conversion schemes may be applied to the (square root of the) original grayscale image, for example, halftone, ordered, Jarvis, Stucki, Floyd Steinberg, or Cardinality-distribution. The relay optics which form an image of the source-conditioning DMD on the projector DMD are designed such that the spatial gray-scaled image displayed by the source-conditioning DMD is converted to an intensity gray-scaled image at the image plane at the projector DMD. The source-conditioning DMD can also be moved out of focus to induce a more complete conversion of the spatial gray-scaled image at the source-conditioning DMD to intensity gray-scaled image at the projector DMD. The relay optics and defocus therefore function as a low pass filter on the binary image projected by the source-conditioning DMD. Because no pulse width modulation is applied at the source-conditioning DMD, the structured illumination in this case is effectively analog with no grayscale digitization.

The image stream to be displayed by the projector DMD is also transformed. For this, the original image is divided by a de-resolved version of the binary image displayed by the source-conditioning DMD. The de-resolve accounts for the effects of the relay optics' resolution as well as the extent of defocus. Logic is also applied to threshold zero values such that divide by zero is negated. The product of the analog structured illumination and the grayscale digitized projector DMD image produces an analog total projected image with no grayscale digitization.

A second realization of this concept has both the source-conditioning DMD and the projector DMD operating in grayscale mode via pulse width modulation where the bit display order of the source-conditioning DMD is coordinated with the bit display order of the projector DMD such that the desired intensity grayscale levels are realized in the total projected images by the two DMDs in series. The grayscale bit depth of the total projected image is the product of the grayscale bit depths of the source-conditioning and projector DMDs. This concept can also be realized via spatially gray-scaling both the source and projector DMDs each operating in either binary or grayscale mode via pulse width modulation.

DRAWING 2 shows one embodiment of the structured illumination of a DMD where the optical source 8 illuminates the source-conditioning DMD 11 by first using source lens 9 to form an image of the source on source lens 10. Source lens 9, which is then imaged onto the source DMD 11 by source lens 10, thus providing moderately uniform illumination of the source DMD 11. In this configuration the source-conditioning DMD is illuminated at normal incidence (i.e. the incident radiation strikes the plane of the micromirror array at a right angle). A relay lens 12 then forms an image of the ON-state energy reflected by the source-conditioning DMD on the micromirror array of projector DMD 13. In this configuration the projector DMD is illuminated at a 24° angle of incidence such that the tilt of the source-conditioning DMD plane is compensated at the projector DMD plane. The optical resolution of the second imaging lens 4 will allow for an extent of blurring of the binary spatially gray-scaled image projected by the source-conditioning DMD to ensure that all ON-state pixels in the projection DMD are fully illuminated. The source-conditioning DMD can also be positioned off of conjugate relative to the projector DMD to provide additional blurring. The on-state energy from the projector DMD is then collimated or imaged onto a screen by a projector lens 14. Similar configurations can also be realized at other angles of incidence and reflection at both the source-conditioning and projector DMDs.

DRAWING 3 shows another embodiment of the structured illumination of a DMD where a multi-spectral band system is realized. In this configuration, the optical source 15 illuminates the source-conditioning DMD 19 via a telecentric Koehler configuration of source lenses. The first source lens 16 is used to form an image of the optical source on the second source lens 17. The second source lens in combination with the source lens 18 telecentrically forms an image of the first source lens on the source-conditioning DMD 19. In this configuration the source-conditioning DMD 19 is illuminated at normal incidence. Relay lenses 21, 23, and 28 are used to form images of the on-state energy reflected by the source-conditioning DMD 19 on the two projector DMDs 24 and 29 while maintaining telecentric operation. A dichroic beamsplitter 22 is used between the two relay lenses2l and 23 to spectrally split the illumination, directing the reflected portion through relay lens 28 to projector DMD 29 while the transmitted portion is imaged by relay lens 23 onto projector DMD 24. The ON-state images from the two projector DMDs 24 and 29 are telecentrically collimated or imaged at infinity or onto a screen by projector lenses 31 and spectrally fused by dichroic beam combiner 27. In this configuration the projector DMDs are illuminated at a 24° angle of incidence such that the tilt of the source-conditioning DMD plane is compensated for at the projector DMD planes. The optical resolution of the relay lenses will allow for an extent of blurring of the binary spatially gray-scaled image projected by the source-conditioning DMD. The source-conditioning DMD can also be positioned off of conjugate relative to the projector DMD to provide additional blurring. The multi-spectral band realization can alternatively be done with multiple source-conditioning DMDs, and with more than two spectral channels. This configuration can also be realized with non-telecentric and/or non-Koehler illumination and at other angles of incidence and reflection at both the source-conditioning and projector DMDs.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A DMD-based digital projection system for ultraviolet, visible, and/or infrared radiation in which enhanced contrast is achieved by using a first or source DMD, in combination with a series of lenses, to create an image of the desired scene in the plane of a second, or projection DMD which, when optically projected, creates an image of the desired scene, which image exhibits enhanced contrast and dynamic range by virtue of the selective illumination of the second DMD, which selective illumination serves to illuminate only those portions of the micromirror array which are intended to illuminate corresponding elements of the projected scene; by thus avoiding the illumination of those portions of the projection micromirror array corresponding to dark regions of the projected image, those same portions of the micromirror array are unable to contribute undesired illumination of the projected scene due to scattered, diffracted, or reflected radiation.

2. The system of claim 1 in which infrared images may be projected using standard DMDs, intended for use at visible wavelengths, whose windows have been replaced by windows made from an infrared-transmitting material, which replacement windows have been attached in such a manner as to prevent contamination by particulate materials or by chemicals which might adversely affect the subsequent performance of the DMD.

3. The system of claim 1 in which imaging at two or more different wavelengths or spectral bands may be accomplished by utilizing a single source DMD in combination with separate projection DMDs for each wavelength or spectral band, and by using a first dichroic beam-splitter to separately illuminate the two projection DMDs, and by combining the separate projected images through the use of a second dichroic component.

4. The system of claim 1 in which uniform illumination of the first DMD is provided by Koehler telecentric illumination optics.

5. The system of claim 3 in which separate source DMDs are used for each spectral band.

6. The system of claim 1 in which the image of the source DMD is slightly de-focused to avoid the need for highly precise registration of the source DMD micromirror array on the projection DMD micromirror array.
